(19) United States
(12) Patent Application Publication
(10) Pub. No.: US 2019/0194476 A1
(43) Pub. Date: Jun. 27, 2019

(54) POLYMERIC PROTECTOR COATING

(71) Applicant: 3M INNOVATIVE PROPERTIES COMPANY, St. Paul, MN (US)

(72) Inventors: Kimia Alizadeh, St. Paul (AU); Doo-Hyun Lee, North Ryde (AU); George Di Scala, Carlton (AU); Yu-Chieh Hsu, Woodbury, MN (US); Jon P. Nietfeld, Woodbury, MN (US); Jeffrey J. Schwab, Inver Grove Heights, MN (US)

(21) Appl. No.: 16/329,731

(22) PCT Filed: Aug. 29, 2017
(86) PCT No.: PCT/US2017/048978

§ 371 Date: Feb. 28, 2019

(30) Foreign Application Priority Data
Aug. 30, 2016 (AU) 2016903441

(51) Int. Cl. C09D 5/20; C09D 175/04; C09D 7/63

(52) U.S. Cl. CPC C09D 5/20; B05B 16/00; C09D 7/63; C09D 175/04

(57) ABSTRACT

The present invention generally relates to polymeric surface coatings, and in particular polymeric coatings which are readily peelable and provide a surface protection function from contamination and physical scratching, as well as providing easy identifiability.

### FIELD

The present invention generally relates to polymeric surface coatings, and in particular polymeric coatings which are readily peelable and provide a surface protection function from contamination and physical scratching.

### BACKGROUND

Peelable coatings may provide conveniently removable surface coatings for a variety of products. They may be presented as a sacrificial protector coating for a surface (or part thereof).

A popular form of peelable coating include rubber coatings, applied via aerosol sprays or dip coats, used to decorate car rims, bonnets and door panels. Peelable rubber coatings include rubbers such as styrene-butadiene dissolved in organic solvents such as xylene, ethylbenzene, acetone and methyl ethyl ketone. These solvents release volatile organic compounds (VOC) into the air and are potentially hazardous for both human health and the environment. Regulatory developments have led to stricter use of volatile organic solvents in paints.

As an alternative water-based emulsion coatings have been developed where water replaces organic solvents as the medium in which polymers particles are dispersed. Polyvinyl acetate and acrylic are examples of polymers capable of forming water-based emulsions. Coatings formed by casting a dispersion and allowing it to dry typically form a hard brittle coating. To achieve peelability, the adhesion of the polymer coating to the surface to be coated often needs to be reduced. A technique employed in some coatings is to use a release agent such as paraffinic wax, animal or vegetable oils, all of which contain fatty acids, to reduce the adhesion of the polymer coating to the surface. Several problems associated with the inclusion of release agents containing fatty acids into a coating composition are their tendency to react with metal, stain masonry and wood, as well as its oily texture. Accordingly, those in the art appreciate that the peelability of a coating composition will be somewhat also dependent not only on the compositional make up of the coating composition but the substrate surface coating interaction which is primarily dependent on the nature of the substrate surface.

Other requirements of peelable coatings include having sufficient tensile strength in the coating so that no fracturing occurs either with weathering or upon peeling.

The need to protect working surfaces for increased functional longevity has grown over the years with many surfaces such as metal and powder coated surfaces being susceptible to degradation and oxidation by harsh chemicals such as solvents and acids, as well as cutting techniques which compromise the integrity of the surface by scratching. Providing a protective coating which may be sacrificed and easily peelable offers an attractive solution. Prior art approaches to this solution offer coating compositions having one or more of the following drawbacks: i) not curable at ambient temperature, ii) the requirement of multiple coating applications to achieve an effective thickness, iii) no/mild chemical resistance, iv) necessity of crosslinking agents, v) water dissolvable, vi) the application of heat for peel release, and/or vii) the inability to easily visualize and differentiate the coated surface portion from the uncoated portion.

It is therefore desirable to provide an easily peelable protector coating composition without the use of release agents, one that is chemical resistant, capable of curing at ambient temperatures, and be visually distinct from the surface to which it is applied.

### SUMMARY OF INVENTION

In part, the present invention is based on the discovery that a peelable polymer coating which is able to protect surfaces and can be easily applied, cured at ambient temperature and easily identifiable, can be prepared using a mixture of water dispersible polyurethane resins with different glass-transition temperatures (Tg), together with at least one pH indicator compound.

Accordingly, in one aspect, there is provided a colour changeable and peelable polymer coating composition for coating a surface comprising a mixture of at least one low Tg water dispersed polyurethane (low Tg PU) and at least one high Tg water dispersed polyurethane (high Tg PU), wherein the low Tg PU has a low Tg PU solids content of about 30% to about 50% by weight and the high Tg PU has a high Tg PU solids content of about 30% to about 50% by weight, wherein the ratio of the highTgPU:lowTg PU to form the coating composition is from 10:90% (w/w) to about 90:10% (w/w), and at least one pH indicator compound.

In one embodiment the at least one low Tg PU has a Tg between about −5°-10° C., such as −5°, −4°, −3°, −2°, −1°, 0°, 1°, 2°, 3°, 4°, 5°, 6°, 7°, 8°, 9° or 10° C.

In one embodiment the at least one high Tg PU has a Tg between about 20°-40° C., such as 20°, 21°, 22°, 23°, 24°, 25°, 26°, 27°, 28°, 29°, 30°, 31°, 32°, 33°, 34°, 35°, 36°, 37°, 38°, 39°, or 40° C.

As used herein “Tg water-dispersed polyurethane” refers to a polyurethane resin dispersed in water, wherein the polyurethane resin is characterized by a high or low Tg (or glass-transition temperature). Tg may be measured by ASTM E1356-08. Tg characterizes a temperature of the reversible transition of a polymer resin from a hard and relatively “glassy” state into a molten or rubber-like state as temperature increases. The Tg ranges shown above characterize the range of temperatures over which the glass transition occurs, which is always lower than the melting temperature, (Tm) of the crystalline or glassy state. The “low” therefore refers to a temperature range (−5°-10° C.) which is lower relative to a “high” Tg PU which is characterized with a higher Tg (i.e., a Tg between about 20°-40° C.). It will be appreciated that the term “water-dispersed polyurethane” refers to a polyurethane resin that forms a colloidal system in which particles of the polyurethane are dispersed in water which acts as the continuous phase. Examples of a low Tg water-dispersed PU include Neorez R1005, Neorez R1007, and Neorez R2190 available from DSM. Examples of a water dispersed high Tg PU includes Neorez R2180 and Neorez 2203 available from DSM and Alberdingk U9800 and U9380 available from Alberdingk Boley. The low Tg and high Tg polyurethane dispersions may also be further characterised by their elongation at break strain value. Elongation at break strain is expressed as a percentage and is the ratio of the initial length of a sample and the length at which the sample breaks. A low Tg PU may display an elongation at break strain percentage of between 1000% and 1500%, for example 1000%, 1100%, 1200%, 1300%, 1400% or 1500%. A high Tg PU may display an elongation at break strain percentage of between 100% and 700%, for example 100%, 200%, 300%, 400%, 500%, 600% or 700%.

In another aspect of the invention there is provided a method of forming a colour changeable and peelable polymer coating on a surface, the method comprising the steps of (i) mixing at least one water-dispersed low Tg PU and at least one water-dispersed high Tg PU, wherein the low Tg PU has a low Tg PU solids content of about 30% to about 50% by weight and the high Tg PU has a high Tg PU solids content of about 30% to about 50% by weight, and wherein the ratio range of highTgPU:lowTg PU is from about 10:90% (w/w) to about 90:10% (w/w), to form a coating composition; (ii) applying said coating composition from (i) to a surface; and (iii) curing of the coating composition at ambient temperature on said surface to form the peelable polymer coating.

In an embodiment the mixing step further comprises the addition of at least one other water-dispersible polymer selected from the group consisting of water dispersible polyvinyl acetate copolymer, water dispersible polyurethane acrylic and/or water dispersible polyacrylate.

In an embodiment the mixing step further comprises the addition of at least one coalescing agent.

In certain embodiments the mixing step further comprises the addition of one or more additives selected from the group consisting of defoamers, levelling agents and thickeners.

In certain embodiments the mixing step comprises the addition of one or more additives selected from the group consisting of coalescing agents, defoamers, levelling agents and thickeners.

In one embodiment the pH indicator compound is an organic dye which is able to change the colour of the composition during the curing process.

In a further aspect the invention provides a product wherein at least a portion of the product has been coated with a composition comprising (i) a mixture of at least one low Tg water dispersed polyurethane (low Tg PU) and at least one high Tg water dispersed polyurethane (high Tg PU), wherein the low Tg PU has a low Tg PU solids content of about 30% to about 50% by weight and the high Tg PU has a high Tg PU solids content of about 30% to about 50% by weight, wherein the ratio of the highTgPU:lowTg PU to form the coating composition is from 10:90% (w/w) to about 90:10% (w/w), and (ii) at least one pH indicator compound.

In still a further aspect of the invention there is provided a kit for forming a colour changeable and peelable polymer coating on a surface, the kit comprising a coating composition comprising (i) a mixture of at least one low Tg water dispersed polyurethane (low Tg PU) and at least one high Tg water dispersed polyurethane (high Tg PU), wherein the low Tg PU has a low Tg PU solids content of about 30% to about 50% by weight and the high Tg PU has a high Tg PU solids content of about 30% to about 50% by weight, wherein the ratio of the highTgPU:lowTg PU to form the coating composition is from 10:90% (w/w) to about 90:10% (w/w); and at least one pH indicator compound (ii) an applicator for applying the coating composition to the surface; and (iii) instructions for coating the surface with said composition and curing to form the colour changeable and peelable polymer coating.

### BRIEF DESCRIPTION OF THE DRAWINGS

FIG. 1 shows a graphic depiction of a colour changeable and peelable polymer according to an embodiment of the present invention coated on a paint booth substrate surface.

FIG. 2 shows photographs of the application of a pinkish coating composition according to one embodiment of the present invention to a surface, including 1) loading a spray gun with the colour changeable and peelable coating composition 2) spraying the composition onto a product surface 3) letting the coating composition cure to form a clear film and 4) dry peeling off by hand.

FIG. 3. shows photographs of the application of a yellowish coating composition according to one embodiment of the present invention to a surface, including 1) loading a spray gun with colour changeable and peelable coating composition 2) spraying the composition onto a product surface 3) letting the composition cure to form a clear film and 4) dry peeling off by hand.

FIG. 4 shows photographs of colour changes with the use of different pH indicator compounds.

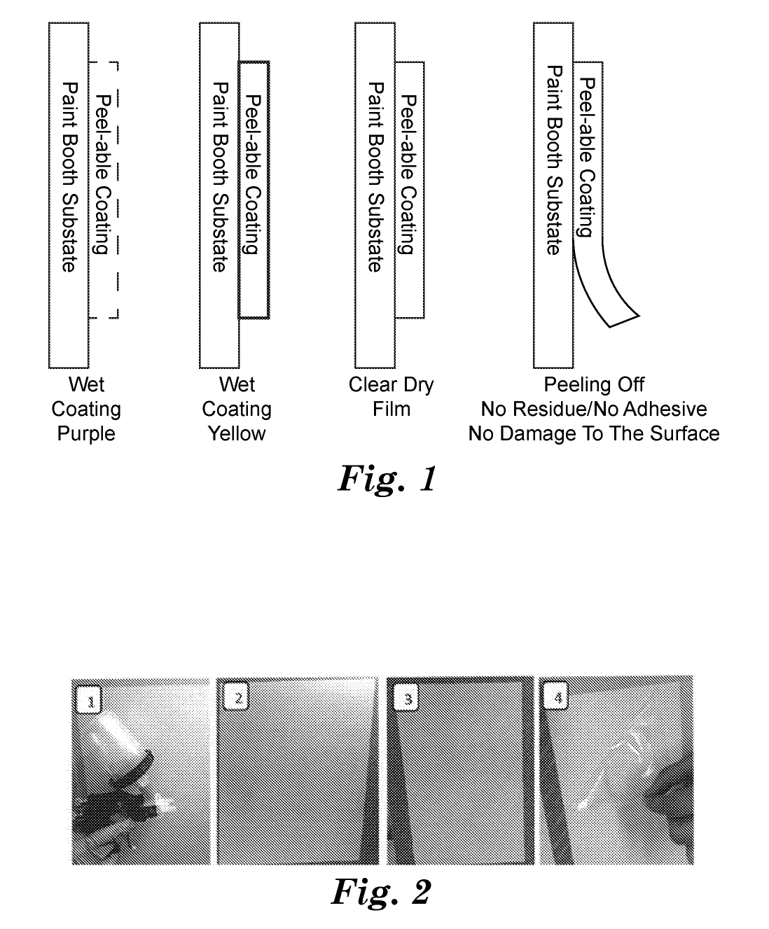

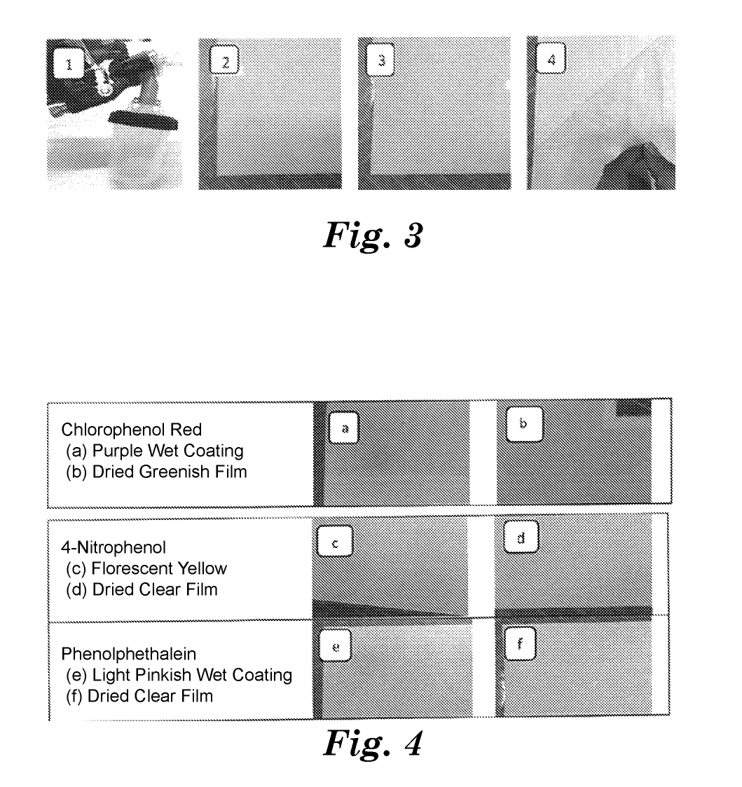

### DETAILED DESCRIPTION

Various aspects of the invention as described herein provide for a colour changeable and peelable polymer coating composition suitable for application on products such as bench tops, whitegoods (i.e., for instance, kitchen and laundry stainless steel appliances), walls, etc., but are also appropriate for use on surface substrates such as metal surfaces, plastics, ceramice, powder coated surfaces and glass.

Advantageously, the colour changeable and peelable polymer coating composition as presently disclosed can (i) add a non-permanent colour to any surface (ii) once cured protect surfaces against scratches, stains and harsh chemical and water degradation (iii) is easily removed by peeling without using laborious chemical, heat or mechanical stripping methods, leaving no residue or damage to the surface. In contemplated applications, the coating composition can be used to protect work benches and other work surfaces from harsh chemicals and paint, or may be used as temporary protection, for instance, for protecting stainless steel or powder coated surfaces, for instance, during storage, transport, delivery and installation. Other applications may include industrial applications, such as automotive paint booth surface protection, surface protection for transportation vehicles (such as buses, trains and trucks) and as a protective coating for complex surfaces, where adhesive films may not be sufficiently conformable to be laid down properly.

It will be appreciated that the coating composition according to the invention will be cured to form a coating on a surface. The term “coating” as used herein refers to the cured composition and the “coating composition” refers to the composition prior to curing.

As used herein, the term “polyurethane” may refer to a polyester-based polyurethane or a polyether-based polyurethane. A polyester-based polyurethane is a polyurethane comprising multiple ester functional groups. A polyether-based polyurethane is a polyurethane comprising multiple ether functional groups. The high Tg polyurethane of the present invention may be a polyester-based polyurethane. The low Tg polyurethane of the present invention may be a polyether-based polyurethane.

The peelable polymer coating composition according to the present invention comprises a mixture of at least one low Tg water-dispersed polyurethane (low Tg PU) and at least one high Tg water-dispersed polyurethane (high Tg PU), wherein the low Tg PU has a low Tg PU solids content of about 30% to about 50% by weight and the high Tg PU has a high Tg PU solids content of about 30% to about 50% by weight, and where the ratio range of highTgPU:lowTg PU is from about 10:90% (w/w) to about 90:10% (w/w). The ratio range includes mixtures of high Tg PU:low Tg PU from about 50:50, 51:49, 52:48, 53:47, 54:46, 55:45, 56:44, 57:43, 58:42, 59:41, 60:40, 61:39, 62:38, 63:37, 64:36, 65:35, 66:34, 67:33, 68:32, 69:31, 70:30, 71:29, 72:28, 73:27, 74:26, 75:25, 76:24, 77:23, 78:22, 79:21, 80:20, 81:19, 82:18, 83:17, 84:16, 85:15, 86:14, 87:13, 88:12, 89:11 and to about 90:10. Conversely the ratio range includes mixtures of high Tg PU:low Tg PU from about 50:50, 49:51, 48:52, 47:53, 46:54, 45:55, 44:56, 43:57, 42:58, 41:59, 40:60, 39:61, 38:62, 37:63, 36:64, 35:65, 34:66, 33:67, 32:68, 31:69, 30:70, 29:71, 28:72, 27:73, 26:74, 25:75, 24:76, 23:77, 22:78, 21:79, 20:80, 19:81, 18:82, 17:83, 16:84, 15:85, 14:86, 13:87, 12:88, 11:89, to about 10:90.

In an embodiment the ratio range of mixtures of highTgPU:lowTg PU is about 90:10 to 70:30.

In an embodiment the ratio range of mixtures of highTgPU:lowTg PU is about 90:10 to 50:50.

In an embodiment the ratio range of mixtures of highTgPU:lowTg PU is about 10:90 to 30:70.

In an embodiment the ratio range of mixtures of highTgPU:lowTg PU is about 10:90 to 50:50.

The compositions of the present invention include at least one pH indicator compound. As used herein a “pH indicator compound” is a compound which is able to change the colour of the composition from when it is applied to a substrate surface (in an aqueous dispersion) to when the composition cures to form the coating on the surface. Accordingly, one will appreciate that the two main advantages involve (i) the compound acting as an indicator as to when curing is complete and/or (ii) indicating and differentiating the coated surface from the non-coated surface. Suitable pH indicators used in acid/base titration chemistry may be used in the present composition. Such compounds have the ability to change the colour of the solution once there has been a pH change.

Examples of suitable pH indicator compounds for the present invention include: phenolphethalein, paranitrophenol, o-cresolphtalein, chlorophenol Red, phenol Red, Thymolblue, Metacresol Purple, Bromothymol Blue, Brilliant Yellow and Neutral Red. Preferred pH indicator compounds For example, paranitrophenol has the ability to turn the colour of the coating composition into fluorescent yellow at pH above 8.5-14 and change it to colourless from 0 to around 7.6. Phenolphethalein works in a similar way and in a similar range but turns the solution to a pink/purple colour under basic conditions. In an embodiment, the composition is coloured once applied but turns colourless once cured and coated onto a surface. In an embodiment, the pH indicator compound is paranitrophenol. In another embodiment, the pH indicator is o-cresolphthalein.

Without wishing to be bound by any particular theory, the present inventors have devised this colour changing effect by making use of the formation of increased carbonic acid levels during the curing process which decrease the internal pH of the compositions in situ. During the curing process the water (which is used as the continuous phase) in the composition dissipates while also absorbing carbon dioxide from the atmosphere to form carbonic acid. This process continues until an equilibrium is established and no water remains (prior to curing the compositions of the present invention may comprise between 10 to 40% water). This process can be somewhat influenced with the use of buffering agents such as ammonia, or amine-based compounds, so that when a surface is treated with a composition comprising a pH indicator compound, like phenolphethalein, the composition is coloured and becomes colourless once cured (as pH will drop to ˜pH 8). Examples of amine-based compounds include triethanolamine and 2-amino-2-methyl-1-propanol (AMP-95). In some embodiments, the buffering agent is present in an amount of from about 0.05% to about 0.5% wt/wt of the composition. The term ‘peelable’ refers to the property of being removable by physical peeling by hand. Peel strength is a measure of adhesive bond strength. It can be defined by various measurements, such as the average load required to part two bonded materials per unit length separation (N/inch or N/m), or the average load per unit width of bond line required to part two bonded materials where the angle of separation is 90 degrees and separation rate is 50 millimeters per minute (ASTM D6862). For a coating to be peelable, its cohesive strength (i.e. breaking force) should be greater than its adhesive bond strength. Since the adhesive bond strength will vary depending on the nature of the substrate to which the coating is adhered, the coating may be peelable from some substrates and not from others. Once cured on the surface the coating of the invention is specifically suitable for coating stainless steel. The peel strength is preferably between 1-10 N/inch, for instance 1-7 N/inch, 1-6 N/inch, 1-5 N/inch, or 1-4 N/inch, such as about 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8 or 9.9 N/inch.

The peelable and colour changeable coatings described herein have an elongation at break of at least about 100% as measured by ASTM D882, or at least about 150, 250, 350, 400, 450 or 500, or between about 300 and about 1200%, or between about 100 and 800, 100 and 500, 200 and 1200, 600 and 1200 or 400 and 600%, e.g. about 100, 150, 200, 250, 300, 350, 400, 450, 500, 550, 600, 650, 700, 750, 800, 850, 900, 950, 1000, 1050, 1100, 1150 or 1200%.

The coating compositions according to the present invention may be prepared by the use of standard equipment in the art. The high and low Tg PUs may be mixed with the pH indicator compound at ambient temperature (i.e., room temperature) in a container (e.g., bucket) which is exposed to atmospheric conditions. Homogeneity of the mixture may be attained with medium stirring over a 2-10 min mixing period. In an embodiment any additional additives (such as additional water-dispersible polymers, coalescing agents, thickeners, defoamers and leveling agents) are added and subsequently mixed to maintain homogeneity.

The pH indicator compound can be added to the mixture neat or as a solution in water or in a polar coalescing agent such as ethanol or methanol.

In further embodiments, the colour changeable and peelable polymer coating compositions of the present invention may also include one or more other water-dispersible polymers including water dispersible polyvinyl acetate copolymer, water dispersible polyurethane acrylic and/or water dispersible polyacrylates. In an embodiment the wt/wt % of the additional polymers is from about 1-30%, such as about 2, 3, 4, 5, 6, 7, 8, 9, 10, 11, 12, 13, 14, 15, 16, 17, 18, 19, 20, 21, 22, 23, 24, 25, 26, 27, 28, 29 to about 30%; and any range using two of the aforementioned figures. For instance, in an embodiment the ratio of low and high PU:to at least one water-dispersible polymer selected from the group consisting of water dispersible polyvinyl acetate copolymer, water dispersible polyurethane acrylic and/or water dispersible polyacrylates is from about 70:30 to 90:10, such as about 71:29, 72:28, 73:27, 74:26, 75:25, 76:24, 77:23, 78:22, 79:21, 80:20, 81:19, 82:18, 83:17, 84:16, 85:15, 86:14, 87:13, 88:12, 89:11, to about 90:10.

Accordingly, in a further embodiment the invention provides a colour changeable and peelable polymer coating composition comprising: (i) a mixture of at least one low Tg water dispersed polyurethane (low Tg PU) and at least one high Tg water dispersed polyurethane (high Tg PU); (ii) a pH indicator compound and; (iii) at least one further water dispersible polymer selected from the group consisting of water dispersible polyvinyl acetate copolymer, water dispersible polyurethane acrylic and/or water dispersible polyacrylates; and wherein the low Tg PU has a low Tg PU solids content of about 30% to about 50% by weight and the high Tg PU has a high Tg PU solids content of about 30% to about 50% by weight, wherein the ratio of the high Tg PU:low Tg PU to form the coating composition is from 10:90% (w/w) to about 90:10% (w/w).

In a further embodiment the invention also provides a colour changeable and peelable polymer coating composition comprising: (i) a mixture of at least one low Tg water dispersible polyurethane (low Tg PU) and at least one high Tg water dispersed polyurethane (high Tg PU); (ii) a pH indicator compound and; (iii) at least one further water-dispersed polymer selected from the group consisting of water dispersible polyvinyl acetate copolymer, water dispersible polyurethane acrylic and/or water dispersible polyacrylates; and wherein the low Tg PU has a low Tg PU solids content of about 30% to about 50% by weight and the high Tg PU has a high Tg PU solids content of about 30% to about 50% by weight, wherein the ratio of the highTgPU:lowTg PU to form the coating composition is from 10:90% (w/w) to about 90:10% (w/w), and wherein the ratio range of high/low Tg PU:the at least one further water-dispersible polymer is from 70:30 to 90:10.

In a further embodiment the colour changeable and peelable polymer coating composition for coating a surface comprises: (i) a mixture of at least one low Tg water dispersed polyurethane (low Tg PU) and at least one high Tg water dispersed polyurethane (high Tg PU), the low Tg PU has a low Tg PU solids content of about 30% to about 50% by weight and the high Tg PU has a high Tg PU solids content of about 30% to about 50% by weight, wherein the ratio of the high Tg PU:low Tg PU to form the coating composition is from 10:90% (w/w) to about 90:10% (w/w), (ii) at least one pH indicator compound and; (iii) at least one coalescing agent.

In another embodiment the colour changeable and peelable polymer coating composition for coating a surface comprises: (i) a mixture of at least one low Tg water dispersed polyurethane (low Tg PU) and at least one high Tg water dispersed polyurethane (high Tg PU), the low Tg PU has a low Tg PU solids content of about 30% to about 50% by weight and the high Tg PU has a high Tg PU solids content of about 30% to about 50% by weight, wherein the ratio of the high Tg PU:low Tg PU to form the coating composition is from 10:90% (w/w) to about 90:10% (w/w); (ii) at least one pH indicator compound; (iii) at least one coalescing agent; (iv) at least one thickener; (v) at least one defoamer; and (vi) at least one leveling agent.

Coalescing agents may be used for optimizing the film formation process of the polymeric binder particles by reducing the minimum film formation temperature (MFFT) of the dispersions. The film formation process in polymer dispersions involves the coalescence of the polymeric particles, during and after the evaporation of the water, thereby permitting contact and fusion of adjacent polymer dispersion particles. Coalescing agents typically reduce the MFFT and as a consequence may serve to improve film formation by avoiding crack formation on the film surface. Suitable coalescing agents include partially or moderately hydrophobic organic solvents and are less volatile (i.e. have a slower evaporation rate) than water. Examples of suitable coalescing agents include butoxydiglycol, butyl glycol, glycol ethyl ether, diethylene glycol ethyl ether, alkylene glycol ethers such as ethylene glycol monomethyl ether, ethylene glycol monohexyl ether, ethylene glycol monoethyl ether, ethylene glycol mono-n-butyl ether, diethylene glycol monomethyl ether, diethylene glycol mono-n-butyl ether, propylene glycol monomethyl ether, dipropylene glycol monomethyl ether, dipropylene glycol n-butyl ether, tripropylene glycol monomethyl ether, ethylene glycol monoisobutyl ether, diethylene glycol monoisobutyl ether, propylene glycol monoisobutyl ether, ethylene glycol monophenyl ether, propylene glycol monophenyl ether, ethylene glycol monomethyl ether acetate, ethyl diglycol, butyl diglycol and mixtures of any two or more thereof. In a preferred embodiment, the coalescing agent used in the coating composition is dipropylene glycol n-butyl ether.

The coalescing agent is preferably present in the coating composition at a concentration of between about 1 to 8% by weight, for example, 1%, 2%, 3%, 4%, 5%, 6% 7% or 8% by weight.

Suitable thickeners for the present application are those which are also sometimes described as rheology modifiers which are added to control the viscosity of the composition. A suitable rheology modifier should preferably serve both functions of building up the viscosity of the coating composition and improving its anti-sagging properties. Thus thickness and anti-sagging agents are used interchangeably herein. For applications on non-horizontal surfaces, anti-sagging is an important property. It will be appreciated that the eventual thickness of the coating will depend on orientation of the surface to which the coating composition is applied. It will be appreciated that the viscosity of the coating composition will be determined by considering both the orientation of the surface to which the composition is to be applied and the method by which the composition is to be applied. For example, a coating composition to be applied to a vertical surface may have a viscosity of between about 1000 cPs to about 5400 cPs in order to provide a coating of a suitable thickness, where the method of application is by using a brush, a roller or an adhesive spreader. A coating composition to be applied to a horizontal surface may have a viscosity of between about 400 cPs to 1000 cPs, in order to provide a coating of a suitable thickness and smooth appearance. Where the method of application is by spraying on to a vertical or horizontal surface, a composition with lower viscosity is required. For example, a coating composition to be applied by spray application may have a viscosity of about 100 cPs to about 500 cPs.

A suitable thickener (or anti-sagging agent) may be an associative thickener. Examples of a suitable thickener include Coapur 5035, Coapur 5535, Rheolate 278, Acrysol RM-8, and Coatex BR-100P. An example type of preferred thickener is hydrophobically modified ethoxylate urethanes (HMEU).

The thickener (or anti-sagging agent) may be present in the composition in an amount of from 0.1% to about 5% (w/w).

When using a thickener the composition may be allowed to stand for a period of from 2 hrs-30 hrs to allow the viscosity to build up prior to application to a surface.

The compositions disclosed herein may also include a defoamer, which prevents the formation of bubbles in the coating and destroys any bubbles that do form. Examples of suitable defoamers include silicon-based defoamers such as polysiloxane defoamers. Particular defoamers include polydimethylsiloxane with a HLB value of about 1 to 3, BYK 094, BYK 024, BYK 029, Tegofoamex 825, Drewplus S-4386, Drewplus S-4287 and Drewplus S4288. The defoamer may be added to reduce the formation of foaming when the composition is applied to the surface.

The compositions disclosed herein may also include a levelling agent, which ensures that the surface of the coating obtained from the coating composition self levels. Examples of suitable levelling agents include silicon-based wetting agents such as polysiloxane wetting agents. Particular levelling agents include polydimethylsiloxane, Tego Wet 250, BYK 333, BYK 346, BYK 348 and BYK 349.

Since the defoamer and the levelling agent are similar in both chemical structure and nature, they can be used interchangeably in the composition. In an embodiment, a composition of the present invention may comprise a defoamer or a levelling agent. In another embodiment, a composition of the present invention may comprise both a defoamer and a levelling agent.

The defoamer and the levelling agent may be present in the composition in a combined amount of from 0.05% to about 2.0% (w/w).

The colour changeable and peelable color coating may be formed as a single layer adhering directly to the surface to be coated or a portion thereof, with no intermediate surface release agent required to facilitate peeling. The surface or the portion thereof to be coated may be in a vertical orientation, a horizontal orientation or an orientation intermediate to the vertical and horizontal orientations. The single layer coating may be applied by a spray gun, paint brush, roller or comb like applicator device, such as an adhesive spreader. In this regard, the coating thickness may range from a thin layer of 100 microns, or 10 microns, or less, to a thick layer of 1000 microns, or 10000 microns, or more. In an embodiment the coating thickness is from 0.15-3.5 mm, such as about 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm, 0.3.1 mm, 3.2 mm, 3.3 mm, 3.4 mm or a range based on any two of these figures. In some embodiments for wall coatings, the typical thickness of a coating is in the range of several hundred microns or generally more than 200 microns.

The colour changeable and peelable colour coating may also be formed by the application of more than one layer of the coating composition. The multiple layers coating may be applied by an aerosol, spray gun, an atomizer, adhesive spreader, a paint brush or roller.

In an embodiment, the coating compositions may also include additional polymers, such as a polyurethane-acrylate (PUA) or an acrylic resin. Examples of a polyurethane-acrylate (PUA) include NeoPac E-122 and NeoPac R-9045. Polyurethane-acrylates may display an elongation at break strain percentage of between about 500% to about 750%, for example, 500%, 560%, 610%, 660% or 750%. An acrylic resin may also be a self-crosslinking acrylic. Examples of an acrylic resin include Neocryl XK-12 and Neocryl XK-14. Acrylic resins may display an elongation at break strain percentage of between about 100% to about 310%, for example, 100%, 150%, 200%, 250%, 300% or 310%. The polyurethane-acrylate and acrylic resin together, may be present in the composition in an amount of no greater than 50% of total resins. For example, the concentration of the polyurethane-acrylate and acrylic resin taken together may be 0%, 10%, 20%, 30%, 40% or 50% of the coating composition.

One of the main advantages of the coating compositions of the present invention is that they are curable at ambient temperature and often within about 24 hrs after application.

As a further advantage the coatings produced by the coating compositions disclosed herein are both water and chemical resistant. Water resistance can be measured by a covered spot test (ASTM D1308-02). Chemical resistance has been observed in relation to acids (e.g., isocyanic acid), and organic solvents (e.g., naptha, toluene, xylene, ethylene benzene, N-butyl acetate, etc.). Many of the chemicals mentioned above are used in the automotive aftermarket industry such as panel repair shops. Accordingly, the coatings formed by the compositions disclosed herein may have specific application in the protection of surfaces used in this industry. Surfaces which are used in spray booths are typically powder coated. The present compositions find particular application in the protection of surfaces (including walls and ceilings) of automotive spray booths, i.e., interior or inner surfaces of an automotive spray booth.

To provide the coatings with additional functionalities, additives such as biocides, fillers, fragrance oils, other colouring agents, and anti-cratering agents may also be added to the coating.

### SYNTHESIS EXAMPLES

### Example

A first high Tg polyurethane dispersion (for instance, NeoRez R-2180, DSM NeoResins or Aberdingk U9800 and U9380) and second low Tg polyurethane dispersion (for instance NeoRez R-1005, DSM NeoResins) were mixed by 5 minute-mild stirring at room temperature (amounts were added based on the % w/w ratio's shown in Table 1). A small amount of a coalescing agent such as butoxydiglycol, butyl glycol, glycol ethyl ether, dipropylene glycol n-butyl ether, ester alcohol, and diethylene glycol ethyl ether, is added into the mixture of polymer dispersions. The mixture is stirred at 300 rpm for 5 minutes. Then, additives such as defoamers, leveling agents, pH indicator, pH adjustor and a thickener that is based on polyurethane, were incorporated into the mixture with the mild agitation. The agitation speed was maintained at 300 to 500 rpm for 5 minutes until a homogeneous coating composition was obtained. The coating compositions were then applied to a horizontal stainless steel surface and left to dry at ambient temperature to form a coating. The coating formed displays a transparent film.

### Tests and Observations

Peel Strength of Colour Changeable Peelable Polymer Coating on Sheet Metal Plates.

To evaluate the removable/peelable/aging properties of the colour changeable peelable coating on meal plates, the peel strength test was conducted (ASTM D6862), by aging in a 50° C. oven for up to 28 days. The test is based on 90 degree peel strength test with an Instron machine, head cell weight (5 Kg), cell capacity (100N), head speed (50 mm/min), 15 mm gauge length, and 3 measurements were made for each sample type. Table 1 shows the peel strength of various Mix formulations and pH indicator compounds.

Results.

The results showed that the peel strength of all coating formulations with different polymer types and pH indicators varied from sample to sample. However they all had very low peel strength properties, which can conduct the dry easy peelable function effectively without damaging the substrate.

TABLE 1
Blended polymer formulation verse the raw high
Tg PU tested after 3 days at room temperature and
test results for 1) Peel Strength at 3 days.

| | | | Peel |
|---|---|---|---|
| | Polymer classification in | | Strength |
| Sample | formula | pH indicator | (N/inch) |
| Example 1 | Polyurethane | Chlorophenol Red | 1.57 |
| Example 2 | Polyurethane + Polyvinyl | Chlorophenol Red | 1.06 |
| | acetate copolymer | | |
| Example 3 | Polyurethane + Polyurethane | Chlorophenol Red | 0.69 |
| | acrylic | | |
| Example 4 | Polyurethane + Polyacrylate | Chlorophenol Red | 1.08 |
| Example 5 | Polyurethane | Phenol Red | 1.66 |
| Example 6 | Polyurethane + Polyvinyl | Phenol Red | 1.21 |
| | acetate copolymer | | |
| Example 7 | Polurethane + Polyurethane | Phenol Red | 1.28 |
| | acrylic | | |
| Example 8 | Polyuretahne + Polyacrylate | Phenol Red | 0.96 |
| Example 9 | Polyurethane | Phenolphthalein | 1.22 |
| Example 10 | Polyurethane + Polyvinyl | Phenolphthalein | 0.75 |
| | acetae copolymer | | |
| Example 11 | Polyurethane + Polyurethane | Phenolphthalein | 0.82 |
| | acrylic | | |
| Example 12 | Polyuretane + Polyacrylate | Phenolphthalein | 0.90 |

Chemical Resistant

The chemical resistant properties of the product were evaluated by testing common chemicals (solvent, water-based paint and solvent-based paint) used in a typical paint job in an automotive spray booth. The colour changeable and peelable booth coating compositions were coated on metal panels. After drying at room temperature, a drop of paint and solvent applied on the film and then after 24 hours, the performance of the film was evaluated visually and rated from 0 to 5 (0:very low to 5:excellent). A small glass cap was used to reduce the rate of evaporation of solvent. Table 2 summarizes the evaluation results. All samples showed good chemical resistant which means the chemicals did not damage the surface and the coating resisted the chemicals.

TABLE 2
Chemical resistant rest results

| | | Solvent- | Water- | |
|---|---|---|---|---|
| | Polymer classification in | based | based | |
| Sample | formula | paint | paint | Solvent |
| Example 1 | Polyurethane | 5 | 5 | 5 |
| Example 2 | Polyurethane + Polyvinyl | 4 | 4 | 5 |
| | acetate copolymer | | | |
| Example 3 | Polyurethane + Polyurethane | 5 | 5 | 5 |
| | acrylic | | | |
| Example 4 | Polyurethane + Polyacrylate | 5 | 5 | 5 |
| Example 5 | Polyurethane | 5 | 5 | 5 |
| Example 6 | Polyurethane + Polyvinyl | 4 | 4 | 5 |
| | acetate copolymer | | | |
| Example 7 | Polurethane + Polyurethane | 5 | 5 | 5 |
| | acrylic | | | |
| Example 8 | Polyuretahne + Polyacrylate | 5 | 5 | 5 |
| Example 9 | Polyurethane | 5 | 5 | 5 |
| Example 10 | Polyurethane + Polyvinyl | 4 | 4 | 5 |
| | acetae copolymer | | | |
| Example 11 | Polyurethane + Polyurethane | 5 | 5 | 5 |
| | acrylic | | | |
| Example 12 | Polyuretane + Polyacrylate | 5 | 5 | 5 |

Heat Resistant

Small cubic sample boxes were made out of release paper to provide non-stick property to formed films. 3-5 gr of coating were added to the box. After it was dried its transparency has been checked visually. Then, samples were placed in the oven to mimic the temperature of booth to 80° C. and hold for 1 h. After that, the films were checked if there were any changes in colour. All samples showed a good heat resistant without turning yellow/brown.

Applicator Testing

The choice of applicator design may be deemed advantageous to the final finish coating appearance and also the ease of use to the application. The following application methods have been tested and the results are summarized in the comparison table below, Table 4.

The comb-like application is a recommended application method as it is quick and easy to apply and can achieve a good film build (0.2-0.3 mm) in one coat and also create a high gloss and smooth appearance in the cured coating. The fine tooth of the comb allows excess coating to be pushed along with the applicator to easily spread the coating, but the gaps between the tooth also leaves behind a thin layer of coating to create the desired film build up, which a squeegee, brush or roller cannot readily achieve. Dual lock application works on a similar concept but in this case for a benchtop surface, any bubbles formed becomes obvious to the eye (compared to on a floor application) and is not suitable for application.

TABLE 4
Comparison Table of Applicator Testing

| | No | | | |
|---|---|---|---|---|
| Applicator | of Coats | Film Build | | |
| Type | Required | (mm) | Appearance | Comments |
| Atomizer | 4 | 0.04 ± 0.01 | High gloss or matt | Atomizers require more skill to use, |
| (refillable | (minimum) | | finish | although the no. of coats required is |
| aerosol) | | | | higher and requires longer application |
| | | | | time. Mess free application method. |
| Mohair | 2-3 | 0.2 | Streak lines, roller | Roller and brushes are easy to use but |
| Roller/ | | | patterns and bubbles | leave streak lines and roller patterns |
| Brush | | | are formed when | on the final finish. A minimum of 2 |
| | | | coated with roller | coats is required, which requires some |
| | | | | waiting between coats. Significant |
| | | | | amount of wastage goes in the |
| | | | | applicator. |
| Comb-like | 1 | 0.25 ± 0.03 | High gloss and minimum | Narrow-tooth comb-like applicator is |
| Applicator | | | bubbles | effective to spread the coating and |
| | | | | leaves a desirable film build (0.3 mm) |
| | | | | that creates an easy to peel coating. |
| | | | | Comb-like applications also leave a |
| | | | | pattern free appearance. Wide-tooth |
| | | | | comb applicators can achieve a |
| | | | | similar appearance, but is more |
| | | | | difficult to spread the coating across a |
| | | | | large surface. |
| Dual-lock | 1 | 0.17 ± 0.03 | High gloss but some | Dual-lock applications also can |
| Applicator | | | areas with microbubbles | achieve the desired thickness in 1 coat |
| | | | | but is more difficult to control the |
| | | | | coating edge when coating to the edge |
| | | | | of a substrate. There is some wastage |
| | | | | in the applicator but is insignificant |
| | | | | compared to the rollers. More bubbles |
| | | | | are formed compared to comb |
| | | | | applicators. |

1. A colour changeable and peelable polymer coating composition for coating a surface comprising a mixture of at least one low Tg water dispersed polyurethane (low Tg PU) and at least one high Tg water dispersed polyurethane (high Tg PU), wherein the low Tg PU has a low Tg PU solids content of about 30% to about 50% by weight and the high Tg PU has a high Tg PU solids content of about 30% to about 50% by weight, wherein the ratio of the highTgPU:lowTg PU to form the coating composition is from 10:90% (w/w) to about 90:10% (w/w), and at least one pH indicator compound.

2. A method of forming a colour changeable and peelable polymer coating on a surface, the method comprising the steps of (i) mixing at least one water-dispersed low Tg PU, at least one water-dispersed high Tg PU and at least on pH indicator compound, wherein the low Tg PU has a low Tg PU solids content of about 30% to about 50% by weight and the high Tg PU has a high Tg PU solids content of about 30% to about 50% by weight, and wherein the ratio range of highTgPU:lowTg PU is from about 10:90% (w/w) to about 90:10% (w/w), to form a coating composition; (ii) applying said coating composition from (i) to a surface; and (iii) curing of the coating composition at ambient temperature on said surface to form the peelable polymer coating.

3. A product wherein at least a portion of the product has been coated with a composition comprising (i) a mixture of at least one low Tg water dispersed polyurethane (low Tg PU) and at least one high Tg water dispersed polyurethane (high Tg PU), wherein the low Tg PU has a low Tg PU solids content of about 30% to about 50% by weight and the high Tg PU has a high Tg PU solids content of about 30% to about 50% by weight, wherein the ratio of the highTgPU:lowTg PU to form the coating composition is from 10:90% (w/w) to about 90:10% (w/w), and (ii) at least one pH indicator compound.

4. A kit for forming a colour changeable and peelable polymer coating on a surface, the kit comprising a coating composition comprising (i) a mixture of at least one low Tg water dispersed polyurethane (low Tg PU) and at least one high Tg water dispersed polyurethane (high Tg PU), wherein the low Tg PU has a low Tg PU solids content of about 30% to about 50% by weight and the high Tg PU has a high Tg PU solids content of about 30% to about 50% by weight, wherein the ratio of the high Tg PU:low Tg PU to form the coating composition is from 10:90% (w/w) to about 90:10% (w/w); and at least one pH indicator compound (ii) an applicator for applying the coating composition to the surface; and (iii) instructions for coating the surface with said composition and curing to form the colour changeable and peelable polymer coating.

5. A coating composition, product, method or kit according to claim 1 wherein the low Tg PU has a Tg between −5°-10° C.

6. A coating composition, product, method or kit according to claim 1 wherein the high Tg PU has a Tg between 20°-40° C.

7. A coating composition, product, method or kit according to claim 1, further comprising at least one defoamer, at least one leveling agent and at least one thickener.

8. A coating composition, product, method or kit according to claim 7, further comprising at least one coalescing agent.

9. A coating composition, product, method or kit according to claim 1 wherein the coating composition has a peel strength of between 1-10 N/inch.

10. A surface coated with a composition according to claim 1.

11. A surface according to claim 10, which is an inner surface of an automotive spray booth.

12. A surface according to claim 10 wherein the surface is a powder coated surface.
